(19) United States
(12) Patent Application Publication
(10) Pub. No.: US 2018/0101114 A1
(43) Pub. Date: Apr. 12, 2018

(54) IMAGE FORMING APPARATUS

(71) Applicant: FUJI XEROX CO., LTD., Tokyo (JP)

(72) Inventors: Ko TAKEUCHI, Kanagawa (JP); Hiroshi NAKADA, Kanagawa (JP); Megumi OKUBO, Kanagawa (JP); Kazuyuki OGI, Kanagawa (JP); Hiroko SAITO, Kanagawa (JP); Tsutomu SHIIHARA, Kanagawa (JP); Hidetoshi KIMURA, Kanagawa (JP)

(73) Assignee: FUJI XEROX CO., LTD., Tokyo (JP)

(21) Appl. No.: 15/499,173

(22) Filed: Apr. 27, 2017

(30) Foreign Application Priority Data
Oct. 7, 2016 (JP) 2016-198657

(51) Int. Cl. G03G 15/00

(52) U.S. Cl. CPC G03G 15/5016; G03G 21/1633

(57) ABSTRACT

An image forming apparatus includes a reader reading an image, an image forming section forming an image on a recording medium, an exterior member having an outer surface housing the reader and the image forming section, and an operating display having an outer surface. The operating display is disposed in front of the reader, accepts an operation performed by an operator, displays an image, and is rotatable about a rotational axis disposed on its front side between a position in which the operating display faces an upper side and a position in which the operating display faces the front side. The outer surface of the exterior member has a first region which is a background behind the operating display in front view and which is colored in a color similar to a color of the outer surface of the operating display.

### CROSS-REFERENCE TO RELATED APPLICATIONS

This application is based on and claims priority under 35 USC 119 from Japanese Patent Application No. 2016-198657 filed Oct. 7, 2016.

### BACKGROUND

### Technical Field

The present invention relates to an image forming apparatus.

### SUMMARY

According to an aspect of the present invention, an image forming apparatus includes a reader that reads an image, an image forming section that forms an image on a recording medium, an exterior member that has an outer surface that houses the reader and the image forming section therein, and an operating display that has an outer surface. The operating display is disposed in front of the reader, accepts an operation performed by an operator, displays an image for a user, and is rotatable about a rotational axis disposed on its front side between a position in which the operating display faces an upper side of the image forming apparatus and a position in which the operating display faces the front side. The outer surface of the exterior member has a first region which is a background behind the operating display in front view and which is colored in a color similar to a color of the outer surface of the operating display.

### BRIEF DESCRIPTION OF THE DRAWINGS

Exemplary embodiment of the present invention will be described in detail based on the following figures, wherein:

FIG. 1 is a perspective view of the entirety of an image forming apparatus;

FIG. 2 is a schematic sectional view of an internal structure of the image forming apparatus;

FIG. 3A is a perspective view of an operating display in a folded state seen from an operating display side, and

FIG. 3B is a perspective view of the operating display in an erect state seen from the rear surface side;

FIG. 4 includes a view of an operating display surface of the operating display illustrated at the center and views of the operating display seen from the four directions;

FIG. 5A is a front view of the image forming apparatus with the operating display in the folded state, and FIG. 5B is a side view of the image forming apparatus with the operating display in the folded state;

FIG. 6 is a perspective view of the image forming apparatus with the operating display in the erect state;

FIG. 7A is a front view of the image forming apparatus with the operating display in the erect state, and FIG. 7B is a side view of the image forming apparatus with the operating display in the erect state;

FIG. 8 is a perspective view of the image forming apparatus illustrating thick portions that form edge portions of the exterior members; and

FIG. 9 is a front view of the image forming apparatus illustrating the thick portions that form the edge portions of the exterior members.

### DETAILED DESCRIPTION

Next, the present invention will be described more in detail in the following discussion of an exemplary embodiment with reference to the drawings. However, the present invention is not limited to the exemplary embodiment.

Furthermore, it should be understood that, in the following description with reference to the drawings, the drawings are schematically illustrated and not to scale, and illustration of elements other that elements required for the description are appropriately omitted for ease of understanding.

### (1) A Structure of an Image Forming Apparatus

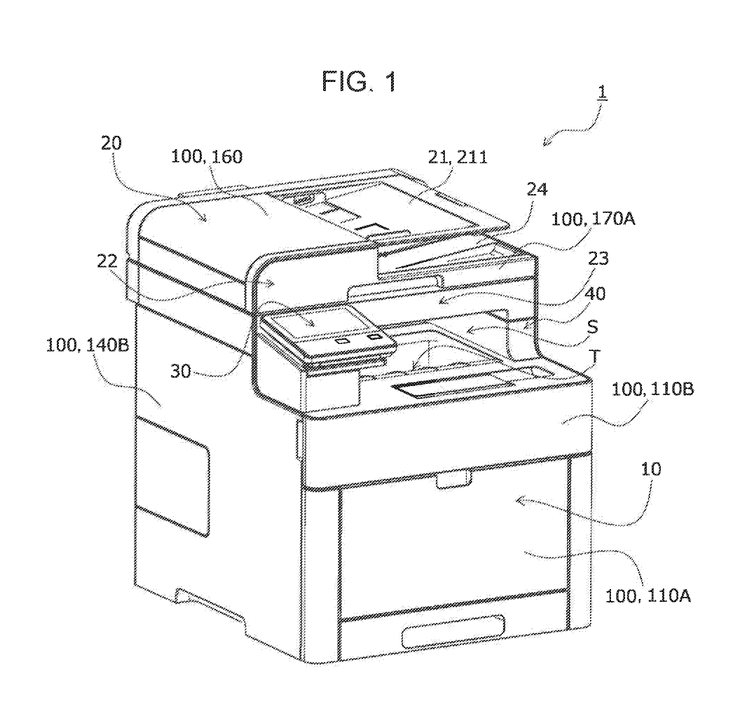

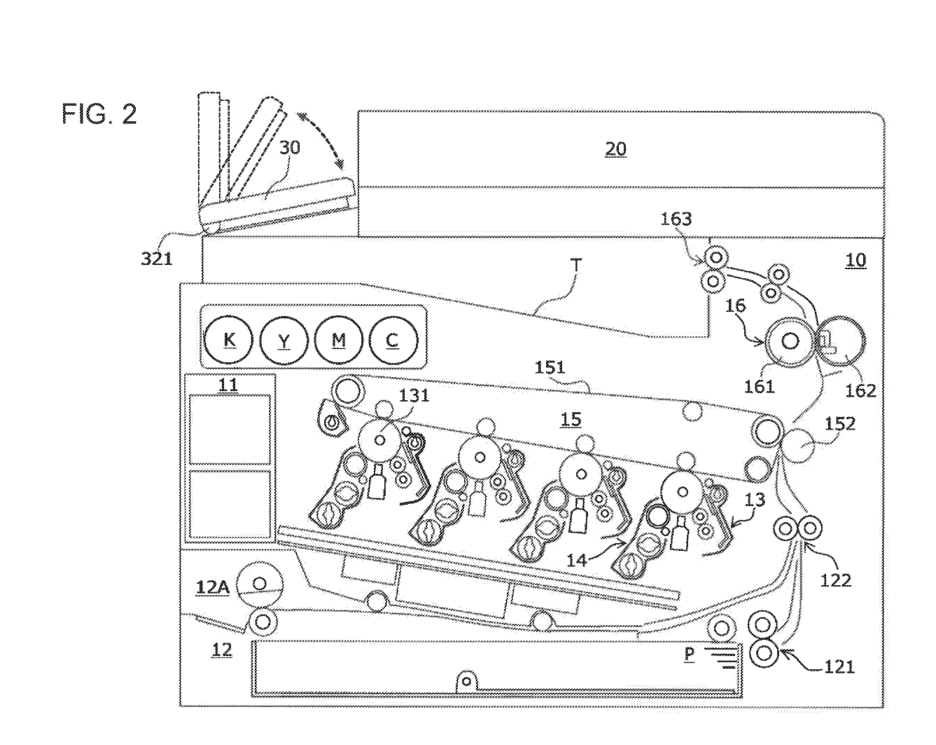

FIG. 1 is a perspective view of the entirety of an image forming apparatus 1 according to the present exemplary embodiment. FIG. 2 is a schematic sectional view of an internal structure of the image forming apparatus 1 according to the present exemplary embodiment.

The overall structure of the image forming apparatus 1 will be described below with reference to the drawings.

The image forming apparatus 1 includes an image forming section 10, a reader 20, and an operating display 30. The image forming section 10 forms images by using the electrophotographic method. The reader 20 is supported above the image forming section 10 by a support member 40 and reads documents and the like. The operating display 30 serves as a user interface.

An in-body space S is formed between the image forming section 10 and the reader 20. A sheet output tray T on which sheets P output from an output roller pair 163 (see FIG. 2) are stacked is formed in the in-body space S.

A controller 11, a sheet feed device 12, photosensitive units 13, developing devices 14, a transfer device 15, and a fixing device 16 are disposed in an inner space formed by a housing F (not illustrated) of the image forming section 10. The housing F (not illustrated) is covered by divided plural exterior members 100 (illustrated in FIG. 1).

The sheet feed device 12 on which the sheets P are stacked is provided at a bottom portion of the image forming section 10. The position of the sheets P in the width direction is determined by a regulating plate (not illustrated). The positioned sheets P are drawn rearward one sheet after another from the top of the stack by a sheet drawing unit 121, and then each of the sheets P is transported to a nip between a registration roller pair 122.

The photosensitive units 13 are arranged in parallel with one another above the sheet feed device 12 and include respective photosensitive drums 131 that are rotated. Toner images of yellow (Y), magenta (M), cyan (C), and black (K) are formed on the respective photosensitive drums 131 by the developing devices 14.

The toner images of the colors formed on the photosensitive drums 131 of the respective photosensitive units 13 are sequentially electrostatically transferred (through first transfer) onto an intermediate transfer belt 151 of the transfer device 15. Thus, superposed toner images are formed by superposing the toner of the colors. The superposed toner images on the intermediate transfer belt 151 are fed from the registration roller pair 122 and collectively transferred by a second transfer roller 152 onto the sheet P which is guided by a transport guide.

The sheet P onto which the toner images have been collectively transferred in the transfer device 15 is transported to the fixing device 16. At this time, the toner images have not yet been fixed. The toner images are fixed onto the sheet P by the action of heat and pressure by using a pair of a heating module 161 and a pressure module 162.

The sheet P on which a fixed toner image has been formed is guided by the transport guide and output from the output roller pair 163 to the sheet output tray T in the in-body space S. The sheet output tray T receives this sheet P thereon.

The reader 20 includes a document loader 21, an auto document feeder 22, and an image reader 23. A document tray 211 is openably provided in the document loader 21. A document in which images are recorded is to be placed on the document loader 21.

The auto document feeder 22 sequentially extracts sheets of a document loaded on the document tray 211 one sheet after another from an uppermost one of the sheets and transports each of the sheets to the image reader 23. The image reader 23 optically reads the images of a document G transported from the auto document feeder 22 and converts the read images into image data which is electrical signals.

When the images on the sheets of the document G have been read by the image reader 23, the sheets of the document G are ejected to a document receiving unit 24 formed below the document loader 21.

The operating display 30 includes a liquid crystal display panel, various operating buttons, a touch panel, and so forth which are combined with one another. A user of the image forming apparatus 1 inputs various settings and instructions through the operating display 30. Also, various types of information for an operator of the image forming apparatus 1 are displayed through the liquid crystal display panel.

As illustrated in FIG. 2, the operating display 30 includes a tilt mechanism to the front of (closer to the operator than) the reader 20. The tilt mechanism allows the operating display 30 to be rotated about a rotational shaft 321 as the rotational axis provided on the front surface side of the operating display 30 between a position in which the operating display 30 faces the upper side of the image forming apparatus 1 and a position in which the operating display 30 faces the front surface side (see an arrow in FIG. 2) and to be operated and visually recognized by the operator either from above or from the front surface side.

### (2) A Structure of an Exterior of an Image Forming Apparatus

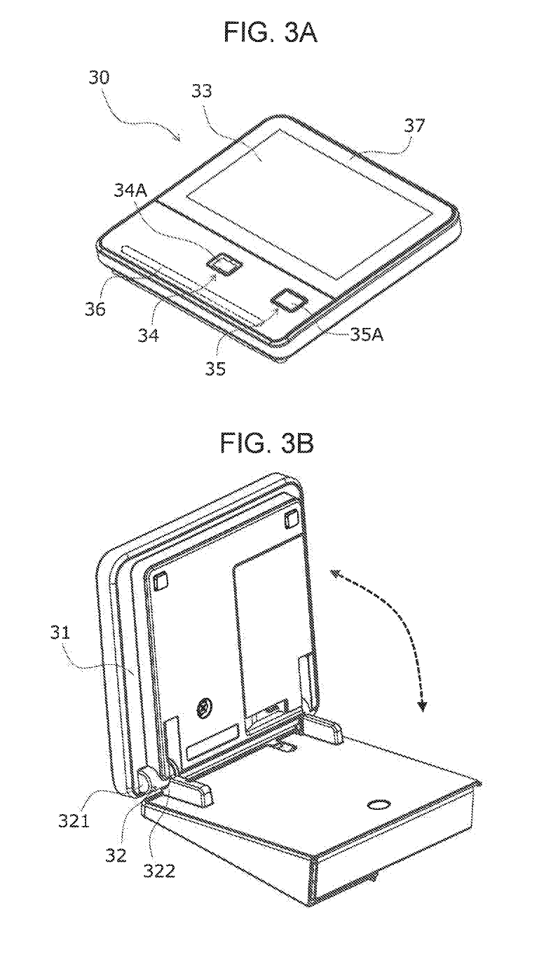

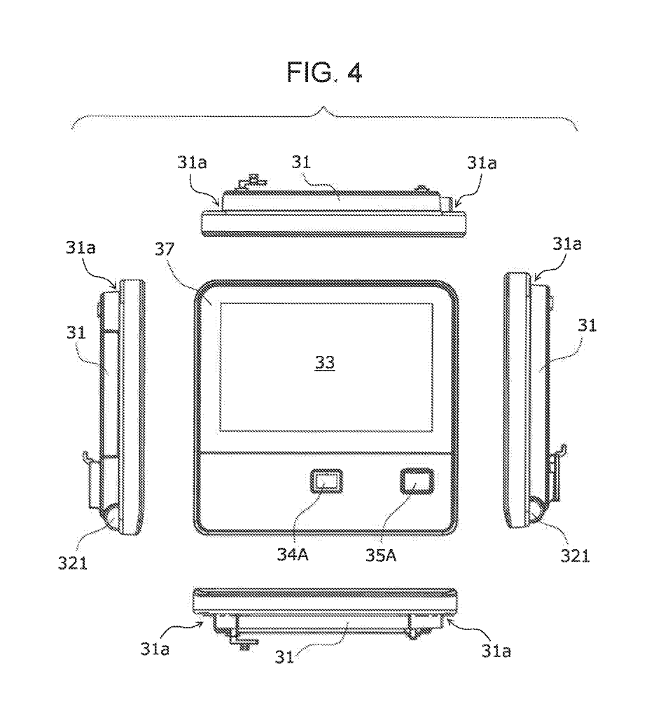

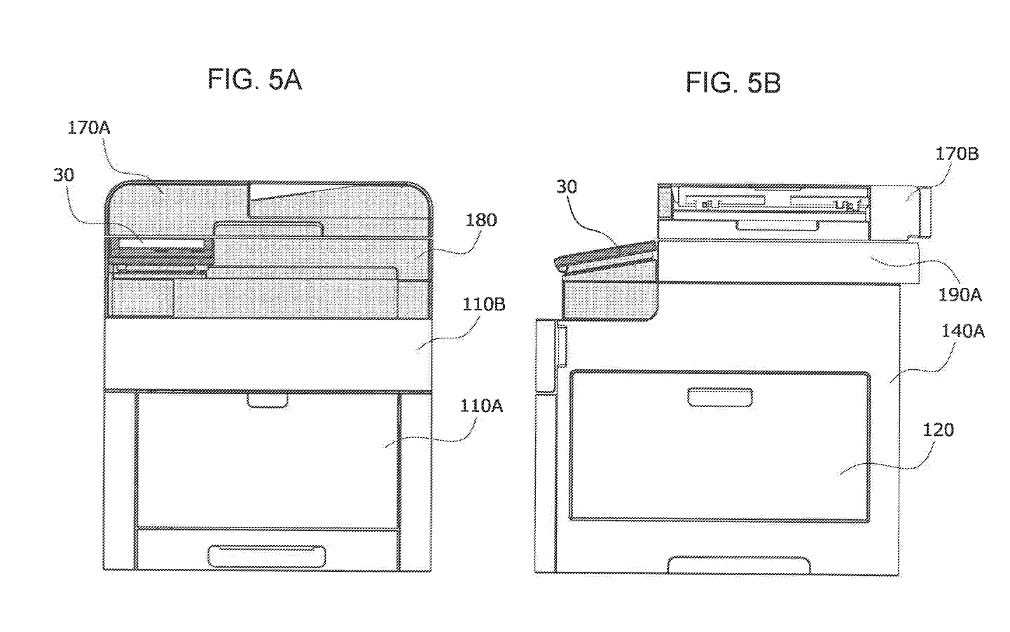

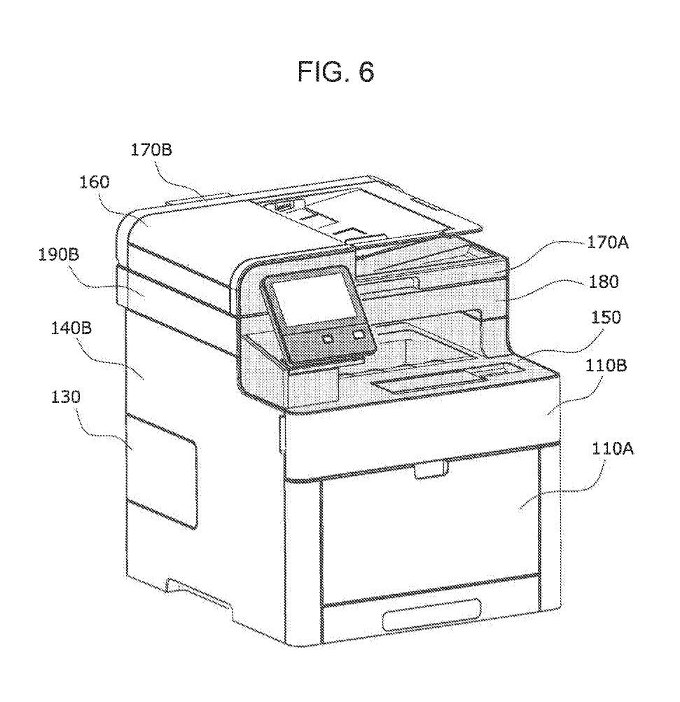

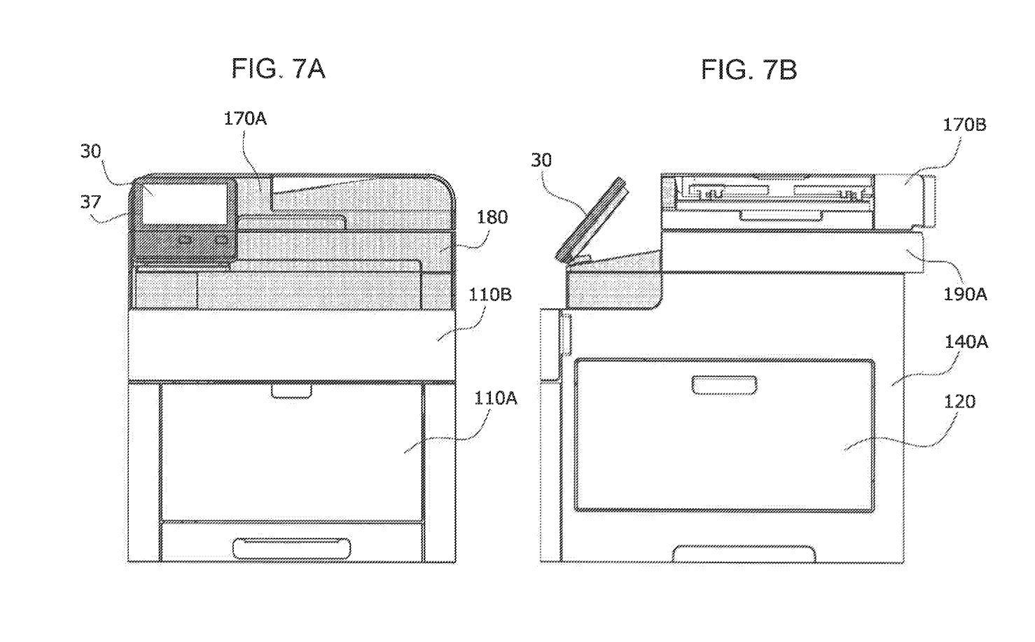

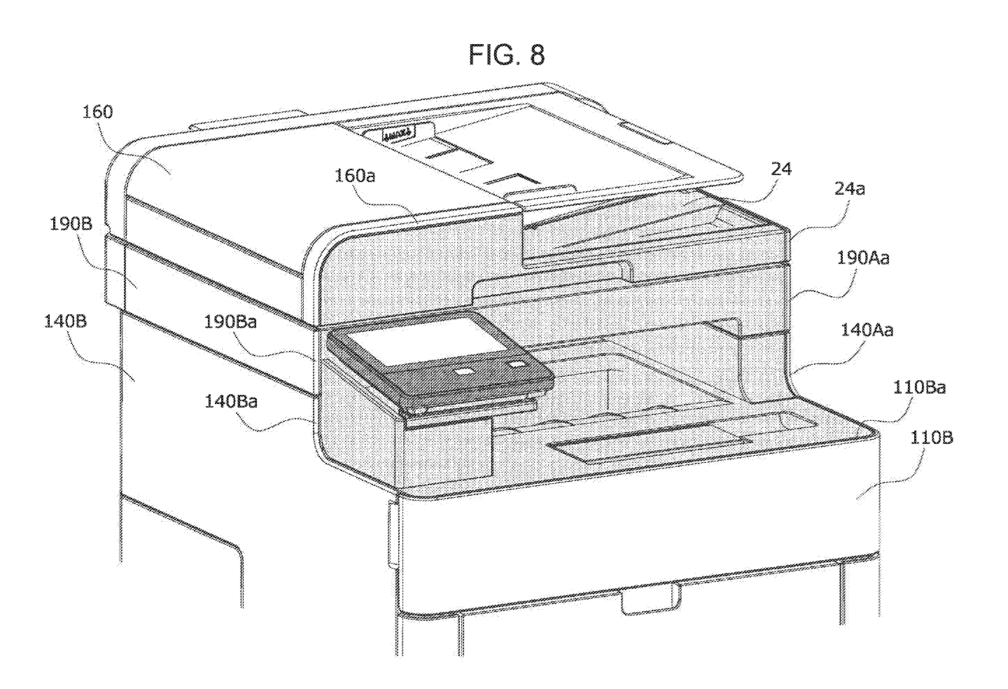

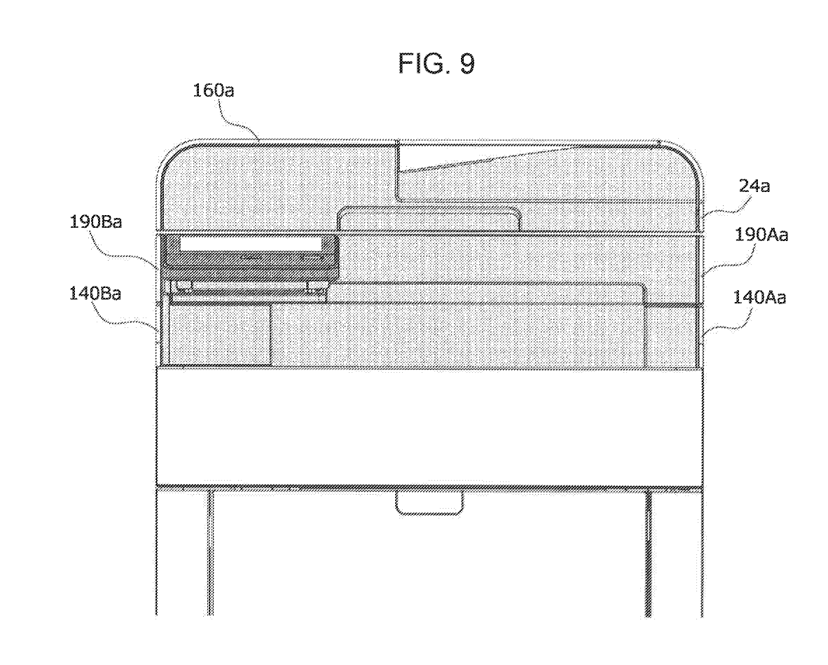

FIG. 3A is a perspective view of the operating display 30 in a folded state seen from an operating display side. FIG. 3B is a perspective view of the operating display 30 in an erect state seen from the rear side. FIG. 4 includes a view of an operating display surface of the operating display 30 illustrated at the center and views of the operating display 30 seen from the four directions. FIG. 5A is a front view of the image forming apparatus 1 with the operating display 30 in the folded state. FIG. 5B is a side view of the image forming apparatus 1 with the operating display 30 in the folded state. FIG. 6 is a perspective view of the image forming apparatus 1 with the operating display 30 in the erect state. FIG. 7A is a front view of the image forming apparatus 1 with the operating display 30 in the erect state. FIG. 7B is a side view of the image forming apparatus 1 with the operating display 30 in the erect state. FIG. 8 is a perspective view of the image forming apparatus 1 illustrating thick portions that form edge portions of the exterior members 100. FIG. 9 is a front view of the image forming apparatus 1 illustrating the thick portions that form the edge portions of the exterior members 100.

### (2.1) The Structure of the Operating Display

As illustrated in FIGS. 3A and 3B, the operating display 30 includes a body housing 31, a support mechanism 32, a display 33, an operating device 34, an operating device 35, a light emitter 36, and a covering member 37.

The display 33 is a touch panel display in which a touch panel is superposed on a display unit such as a liquid crystal display. The display 33 displays an operating screen and accepts selecting operations performed on the touch panel by the operator.

Here, the selecting operations refer to operations performed on the operating screen so as to select items displayed on the operating screen. The selecting operations may be performed by bringing a finger of the operator, a stylus, or the like into contact with the operating screen or performed by bringing the finger of the operator or the like close to the operating screen without being in contact with the operating screen.

The operating device 34 and the operating device 35 respectively include an operating button 34A and an operating button 35A. The operating device 34 and the operating device 35 accept pressing operations performed by the operator and instruct the image forming apparatus 1 to perform processes.

The light emitter 36 (indicated by a broken line in FIG. 3A) is formed in a portion of the covering member 37 included in an exterior of the operating display 30 and emits light of a predetermined color so as to indicate a state of the image forming apparatus 1.

Light emission through a rear surface of the light emitter 36 is blocked. Thus, when light emitting diodes (LEDs; not illustrated) serving as light sources are turned off, the operator does not visually recognize the light (indicated by the broken line in FIG. 3A).

The support mechanism 32 includes the rotational shaft 321 and hinges 322. The support mechanism 32 supports the body housing 31 such that the body housing 31 is rotatable relative to the image forming apparatus 1. The support mechanism 32 is located on the front surface side of the image forming apparatus 1. The operating display 30 in the erect state does not project from the front surface of the image forming apparatus 1. In this way, an increase in depth dimension occupied by the image forming apparatus 1 including the operating display 30 including the tilt mechanism is avoided (see FIG. 2).

As illustrated in FIG. 4, the body housing 31 has step portions 31a that allow a finger to hook to the covering member 37 at any one of the step portions 31a in a corresponding one of three directions. Thus, even when the operating display 30 is in a normal position in which the operating display 30 is folded and faces upward, the operator is able to rotate the operating display 30 with his or her finger hooked in any one of the step portions 31a in a corresponding one of the three directions.

### (2.2) The Structures of the Exterior Members

As illustrated in FIGS. 5A, 5B, 6, 7A, and 7B, the components of the image forming apparatus 1 are covered with the plural exterior members 100. The image forming section 10 is disposed inside the exterior members 100. The reader 20 is also covered with the plural exterior members 100, and the support member 40 that supports the reader 20 above the image forming section 10 is also covered with the plural exterior members 100.

The exterior members 100 that cover the image forming section 10 include a front covering 110A, a front covering 110B, a right openable covering 120, a left openable covering 130, a left side covering 140B, a right side covering 140A, and an upper surface covering 150. A sheet tray (not illustrated) of a manual feed device 12A (see FIG. 2) is disposed behind the front covering 110A. The front covering 110A is opened when manually feeding sheets. The front covering 110B is opened and closed so as to attach and detach toner cartridges (see FIG. 2). The right openable covering 120 is opened and closed to deal with jamming of the sheet P. The left openable covering 130 is opened and closed to connect electronic components such as a board and memory to the controller 11. The left side covering 140B and the right side covering 140A cover respective sides of the image forming section 10. The sheet output tray T is formed in the upper surface covering 150.

The openable covers by which outer surfaces visible to the user are partially formed are colored white or a bright color formed of a light color.

The reader 20 is covered with the exterior members 100 that include an upper openable covering 160, a front covering 170A, and a rear covering 170B. The upper openable covering 160 is opened and closed to deal with jamming of the document in the auto document feeder 22. The front covering 170A and the rear covering 170B are integrally formed with the document receiving unit 24.

Furthermore, the image reader 23 is covered with the exterior members 100 including a front covering 180, a left side covering 190B, and a right side covering 190A. The front covering 180 faces the operating display 30. The left side covering 190B and the right side covering 190A cover respective sides of the image reader 23.

The upper openable covering 160 and the rear covering 170B by which the outer surfaces which are visible to the user are partially formed are colored white or a bright color formed of a light color.

Outer sides of the support member 40 are respectively integrally covered with the left side covering 140B and the right side covering 140A that cover the respective outer sides of the image forming section 10. The front side and the inner side of the support member 40 are integrally covered with the upper surface covering 150 that covers an upper surface of the image forming section 10.

The operating display 30 is provided on the front surface side of the image forming apparatus 1 covered with the exterior members 100 structured as described above. The operating display 30 is rotatable between the normal position in which the operating display 30 is folded and faces the upper side of the image forming apparatus 1 and an erect position in which the operating display 30 faces the front side of the image forming apparatus 1. The operating display 30 is disposed in such a form that the operating display 30 is able to be visually recognized and operated by various operators.

For the operator who visually recognizes and operates the operating display 30, a region of outer surfaces of the exterior members 100 which exists further to the rear side than the operating display 30 and which is visually recognized as a region outside the covering member 37 and overlaid with the operating display 30 is visible to the operator as a background region against the operating display 30.

Specifically, when the operating display 30 assumes the normal position in which the operating display 30 faces the upper side of the image forming apparatus 1, the upper surface covering 150 that covers the upper surface of the image forming section 10 and the front covering 180 that covers the image reader 23 and faces the operating display 30 are included in the background region.

When the operating display 30 assumes the erect position in which the operating display 30 faces the front side of the image forming apparatus 1, part of the upper surface covering 150 that covers the upper surface of the image forming section 10, the front covering 180 that covers the image reader 23 and faces the operating display 30, and the front covering 170A that covers the auto document feeder 22 and is integrally formed with the document receiving unit 24 are included in the background region.

In the case where the background region behind the operating display 30 and the covering member 37 that separates the display 33 from other portions are completely different from each other in color and largely different from each other in lightness when the content of the display in the display 33 is checked in or operations are performed on the operating display 30 as described above, it may be difficult to focus the user's awareness.

With the image forming apparatus 1 according to the present exemplary embodiment, the outer surface of the reader 20 and the outer surface of the image forming section 10 that are included in the background behind the operating display 30 in front view are colored in a similar color to that of the outer surface of the operating display 30.

Specifically, the outer surface of the upper surface covering 150 that covers the upper surface of the image forming section 10, the outer surface of the front covering 180 for the image reader 23 and facing the operating display 30, and the outer surface of the front covering 170A integrally formed with the document receiving unit 24 of the auto document feeder 22 are colored to have a lightness of 2.8 or smaller in Munsell value (Japanese Industrial Standard (JIS) Z 8721) so that the difference between the lightness thereof and the lightness of the outer surface of the operating display 30 is 1.2 or smaller in Munsell value.

Accordingly, even when the operating display 30 is erected from the normal position to the erect position as illustrated in FIG. 6, the entirety of the operating display 30 becomes substantially indistinguishable from the outer surfaces of the exterior members 100 colored in a similar color. Thus, regarding the operator of the operating display 30, the operator's awareness of operation may be improved, and the visibility and the operability of the operating display 30 may be maintained in a good state.

As indicated by shaded areas in FIGS. 5A, 5B, 6, 7A, and 7B, the outer surfaces of the reader 20 and the image forming section 10 that are the background behind the operating display 30 in front view are colored in a dark color compared to the color of the outer surfaces of the other portions of the exterior members 100.

Specifically, the outer surface of the upper surface covering 150 that covers the upper surface of the image forming section 10, the outer surface of the front covering 180 for the image reader 23 and facing the operating display 30, and the outer surface of the front covering 170A integrally formed with the document receiving unit 24 of the auto document feeder 22 are colored in a color of a lightness of 2.8 or smaller in Munsell value (such as dark gray or dark blue) so that the difference between the lightness thereof and the lightness of the outer surfaces of other portions of the exterior members 100 is 5.5 or larger in Munsell value.

Thus, a normal operating region in which the frequency of the operations performed through the operating display 30 is high and a maintenance region in which the frequency of the operations such as replenishment of the sheets, replacement of the toner cartridges, dealing with jamming, and connection of electronic components is low may be clearly distinguished from each other in the image forming apparatus 1 so as to maintain the visibility and the operability of the operating display 30 in a better state.

Furthermore, since the upper surface covering 150 in which the sheet output tray T is formed and the document receiving unit 24 of the auto document feeder 22 are colored in a dark color of the lightness of 2.8 or smaller in Munsell value, the sheets having a high lightness in Munsell value are easily recognized.

Accordingly, when the document is placed on a document table of the image reader 23, the document may be easily distinguishable from the document table. Also, the document having fed by the auto document feeder 22 and ejected onto the document receiving unit 24 may be prevented from being forgotten to be removed.

### (2.3) A Housing Structure of the Exterior Members

As illustrated in FIGS. 8 and 9, the outer surfaces visible to the user are partially formed by the thick portions that form edge portions of the exterior members 100. The thick portions are white or a bright color formed of a light color which is different from the color of the colored outer surfaces, thereby the thick portions surround the outer surfaces of the reader 20 which are the background behind the operating display 30 in front view and the outer surface of the image forming section 10.

Specifically, the following thick portions are colored in a color of a lightness of 8.3 or larger in Munsell value so that the difference in lightness between these thick portions and the outer surface of the reader 20 that is the background behind the operating display 30 and the outer surface of the image forming section 10 is 5.5 or larger in Munsell value: a thickness portion 160a of the upper openable covering 160 of the reader 20; thick portions 190Ba and 190Aa of the left side covering 190B and the right side covering 190A of the image reader 23; a thick portion 24a of the right side covering of the document receiving unit 24; thick portions 140Ba and 140Aa of the left side covering 140B and the right side covering 140A that cover the respective sides of the image forming section 10; and a thick portion 110Ba of the front covering 110B.

Thus, the image forming section 10 and the reader 20 included in the image forming apparatus 1 are integrally surrounded by the edge portions having the lightness largely different from the lightness of the image forming section 10 and the reader 20. Thus, an impression that the image forming apparatus 1 is integrally housed as a system in the exterior members 100 may be given, and the user's awareness may be focused on the operations.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a reader that reads an image;
an image forming section that forms an image on a recording medium;
an exterior member that has an outer surface that houses the reader and the image forming section therein; and
an operating display that has an outer surface,
wherein the operating display is disposed in front of the reader, the operating display accepts an operation performed by an operator, and the operating display displays an image for a user,
wherein the operating display is rotatable about a rotational axis disposed on its front side between a position in which the operating display faces an upper side of the image forming apparatus and a position in which the operating display faces the front side, and
wherein the outer surface of the exterior member has a first region which is a background behind the operating display in front view and which is colored in a color similar to a color of the outer surface of the operating display.

2. The image forming apparatus according to claim 1,
wherein the outer surface of the exterior member has a second region which is a region other than the first region, and
wherein the color of the first region is darker than a color of the second region.

3. The image forming apparatus according to claim 2,
wherein the color of the first region has a lightness of 2.8 or smaller in Munsell value so that a difference in lightness between the color of the first region and the color of the second region is 5.5 or larger in Munsell value.

4. The image forming apparatus according to claim 1,
wherein the color of the first region has a lightness of 2.8 or smaller in Munsell value so that a difference in lightness between the color of the first region and the color of the outer surface of the operating display is 1.2 or smaller in Munsell value.

5. The image forming apparatus according to claim 1,
wherein the exterior member includes an edge portion, and
wherein a color of the edge portion is white or a bright color formed of a light color different from the color of the first region so as to surround the first region in front view.

6. The image forming apparatus according to claim 5,
wherein the color of the edge portion has a lightness of 8.3 or larger in Munsell value so that a difference in lightness between the color of the edge portion and the color of the first region is 5.5 or larger in Munsell value.

7. The image forming apparatus according to claim 2,
wherein part of the exterior member having the second region includes openable coverings that open to respectively expose an interior of the reader and an interior of the image forming section.

8. The image forming apparatus according to claim 3,
wherein part of the exterior member having the second region includes openable coverings that open to respectively expose an interior of the reader and an interior of the image forming section.
